(19) United States
(12) Patent Application Publication
(10) Pub. No.: US 2023/0115532 A1
(43) Pub. Date: Apr. 13, 2023

(54) COMMUNICATION SYSTEM AND COMMUNICATION METHOD

(71) Applicant: KABUSHIKI KAISHA TOKAI RIKA DENKI SEISAKUSHO, Aichi (JP)

(72) Inventors: Masanori KOSUGI, Aichi (JP); Hideki KAWAI, Aichi (JP); Yohei NIWA, Aichi (JP); Shingo MOCHIZUKI, Aichi (JP); Haruki YAMAMURA, Aichi (JP); Akira HASEGAWA, Aichi (JP)

(21) Appl. No.: 17/913,750

(22) PCT Filed: Mar. 24, 2021
(86) PCT No.: PCT/JP2021/012101

§ 371 Date: Sep. 22, 2022

(30) Foreign Application Priority Data
Mar. 31, 2020 (JP) 2020-063673

(51) Int. Cl. B60R 25/24; G07C 9/00

(52) U.S. Cl. CPC B60R 25/241; G07C 9/00309; G07C 2009/00325

(57) ABSTRACT

A vehicle 2 is provided with an authentication system 4 which enables operating a user's terminal 3 as a key to the vehicle 2. The authentication system 4 performs authentication by means of near-field communication between the terminal 3 and a wireless authentication device 22 and operates a device 20. A determination unit 33 confirms the use state of the terminal 3 at the time when near-field communication was performed, and determines whether or not the confirmed use state of the terminal 3 satisfies a condition for stopping or restricting the key function. If the determination unit 33 has determined that the confirmed use state of the terminal 3 satisfies the condition for stopping or restricting the key function, then a processing unit 36 performs processing for stopping or restricting the key function.

### TECHNICAL FIELD

The present invention relates to a communication system and a communication method that restrict establishment of fraudulent communication using a relay unit.

### BACKGROUND ART

A conventional vehicle may include a known electronic key system that transmits ID information (e.g., key ID) from an electronic key to the vehicle through wireless communication to authenticate the electronic key. This type of electronic key system may be subject to a fraudulent action that uses a relay key to plot a successful authentication irrespective of intention of the user (refer to, for example, Patent Literature 1). For example, when the electronic key is distant from the vehicle, the fraudulent action connects the electronic key to the vehicle and relays an electric wave through one or more relay units so that communication is established between the electronic key and the vehicle. This leads to an accomplishment of authentication without notice to the user and allows a third party to fraudulently unlock a vehicle door or start the engine.

### CITATION LIST

### Patent Literature

Patent Literature 1: Japanese Laid-Open Patent Publication No. 2006-161545

### SUMMARY OF INVENTION

There have been recent proposals to use a terminal such as a sophisticated mobile phone (i.e., smartphone) as a vehicle key. Hence, such terminals need a countermeasure against establishment of fraudulent communication using a relay unit.

It is an objective of the present invention to provide a communication system and a communication method that ensure security against fraudulent communication using a relay unit.

An aspect of the present disclosure is a communication system used for a key function that executes authentication of key information that is registered to a terminal through short-range communication performed between the terminal and a wireless authentication device arranged on an operation subject, and when the authentication is successful, allows the terminal to be used as a key to the operation subject. The communication system includes a determination unit and a processor. The determination unit determines a usage state of the terminal during the short-range communication and determines whether the determined usage state of the terminal satisfies a condition for deactivating or restricting the key function. The processor executes a process for deactivating or restricting the key function when the determination unit determines that the determined usage state of the terminal satisfies the condition for deactivating or restricting the key function.

Another aspect of the present disclosure is a communication method used for a key function that executes authentication of key information that is registered to a terminal through short-range communication performed between the terminal and a wireless authentication device arranged on an operation subject, and when the authentication is successful, allows the terminal to be used as a key to the operation subject. The communication method includes determining, with a determination unit, a usage state of the terminal during the short-range communication to determine whether the determined usage state of the terminal satisfies a condition for deactivating or restricting the key function, and executing, with a processor, a process for deactivating or restricting the key function when the determination unit determines that the determined usage state of the terminal satisfies the condition for deactivating or restricting the key function.

The present invention ensures security against fraudulent communication using a relay unit.

### BRIEF DESCRIPTION OF DRAWINGS

FIG. 1 is a configuration diagram showing a first embodiment of a communication system.

FIG. 2 is a sequence chart showing an example of procedures for authenticating key information registered to a terminal.

FIG. 3 is a sequence chart showing an example of procedures for locking and unlocking a vehicle door through smart entry (registered trademark).

FIG. 4 is a sequence chart showing an example of procedures for starting an engine through a smart engine start.

FIG. 5 is a sequence chart showing an example of operation of a communication system.

FIG. 6 is a schematic diagram showing an example of fraudulent communication using a relay unit.

FIG. 7 is a sequence chart showing a concrete example that deactivates or restricts a key function.

FIG. 8 is a sequence chart showing another concrete example that deactivates or restricts a key function.

FIG. 9 is a configuration diagram showing a second embodiment of a communication system.

FIGS. 10A and 10B are diagrams showing examples of confirming to a user whether to permit the terminal to operate a vehicle.

FIG. 11 is a configuration diagram showing a third embodiment of a communication system.

FIG. 12 is a sequence chart showing an example of operation of a communication system.

### DESCRIPTION OF EMBODIMENTS

### First Embodiment

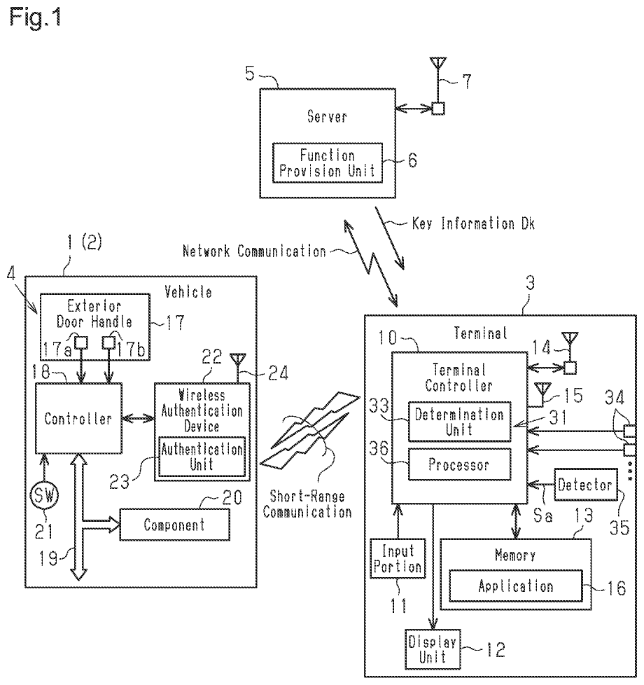

A first embodiment of a communication system and a communication method will now be described with reference to FIGS. 1 to 8.

FIG. 1 shows a vehicle 2 that is an operation subject 1. The vehicle 2 includes a key function (in the present embodiment, authentication system 4) that executes authentication and actuates a component 20 through short-range communication performed with a terminal 3 carried by a user. The authentication system 4 of the present embodiment downloads key information Dk, which is required for the authentication, from a server 5 to the terminal 3 and allows the terminal 3 to operate the vehicle 2. In a preferred example, the terminal 3 is a sophisticated mobile phone. The key information Dk is a type of key that results in successful authentication using short-range communication between the vehicle 2 and the terminal 3 when the vehicle 2 is operated with the terminal 3. In a preferred example, the key information Dk is a one-time key (one-time password) that is valid for a single use or only for a predetermined period.

The server 5 includes a function provision unit 6 that allows the terminal 3 to be operated as a key to the vehicle 2. The function provision unit 6 of the present embodiment delivers the key information Dk, which is required when obtaining a permission to actuate the vehicle 2, to the terminal 3 through a network via a network communication unit 7 arranged on the server 5. It is preferred that when a request for key information provision is received from the terminal 3 of the user through network communication, the key information Dk is delivered to the terminal 3. In a preferred example, the network communication is internet communication.

The terminal 3 includes a terminal controller 10 that controls actuation of the terminal 3, an input portion 11 used when an input operation is performed on the terminal 3, a display unit 12 including a display or the like, memory 13 configured to store data, a network communication portion 14 that performs the network communication with an external device, and a short-range communication module 15 that performs short-range communication. The terminal 3 performs the network communication with the server 5 via the network communication portion 14. The terminal 3 performs short-range communication with the vehicle 2 via the short-range communication module 15. In a preferred example, the display unit 12 is a touch panel.

The memory 13 of the terminal 3 stores an application 16 that is necessary when the terminal 3 is actuated as a key to the vehicle 2. Installation of the application 16 on the terminal 3 allows for a registration of the key information Dk to the terminal 3 and an operation of the vehicle 2 with the terminal 3. In an example, the application 16 is obtained from the server 5 through the network communication and is written and stored to the memory 13. The terminal 3 receives the key information Dk from the server 5 through the application 16 and writes and stores the key information Dk to the memory 13.

The short-range communication may be any of personal area network (PAN) communication and close distance communication. Examples of the personal area network communication include Bluetooth (registered trademark) communication, ultra wide band (UWB) communication, and Wi-Fi (registered trademark) communication. Preferably, Bluetooth communication is Bluetooth Low Energy (BLE). Examples of the close distance communication include near field communication (NFC) and immobilizer communication.

The vehicle 2 includes a controller 18 that controls actuation of the authentication system 4. The controller 18 controls operations of smart entry (registered trademark) function that dispenses with an operation of the terminal 3 when entering and exiting from the vehicle 2, a smart engine start function that dispenses with an operation of the terminal 3 when starting the engine of the vehicle 2, and the like. The controller 18 is connected to the component 20 by a communication line 19 in the vehicle. The communication line 19 is, for example, controller area network (CAN) or local interconnect network (LIN). The component 20 includes, for example, a door lock device that locks and unlocks a vehicle door and the engine of the vehicle 2.

The vehicle 2 includes an exterior door handle 17 including a lock button 17a configured to be operated to lock the vehicle door from the outside of the vehicle. The exterior door handle 17 includes a touch sensor 17b configured to detect a touch of the exterior door handle 17 as a trigger for unlocking the vehicle door. The lock button 17a and the touch sensor 17b are connected to the controller 18. The vehicle 2 includes a driver seat at which an engine switch 21 is arranged. The engine switch 21 is connected to the controller 18 and is operated to shift the vehicle power between different states. The controller 18 controls actuation of the component 20 based on the authentication result of user authentication executed by the authentication system 4.

The vehicle 2 includes a wireless authentication device 22 that executes authentication through short-range communication performed with the terminal 3. The wireless authentication device 22 includes an authentication unit 23 that determines whether the terminal 3 is authentic through wireless communication and a short-range communication antenna (hereafter, simply referred to as antenna 24) that performs short-range communication in the vehicle 2. When the vehicle 2 is operated with the terminal 3, the authentication unit 23 performs short-range communication with the terminal 3 to execute authentication of the key information Dk. In a preferred example, the authentication of the key information Dk is authentication of whether the key information Dk is authentically decrypted.

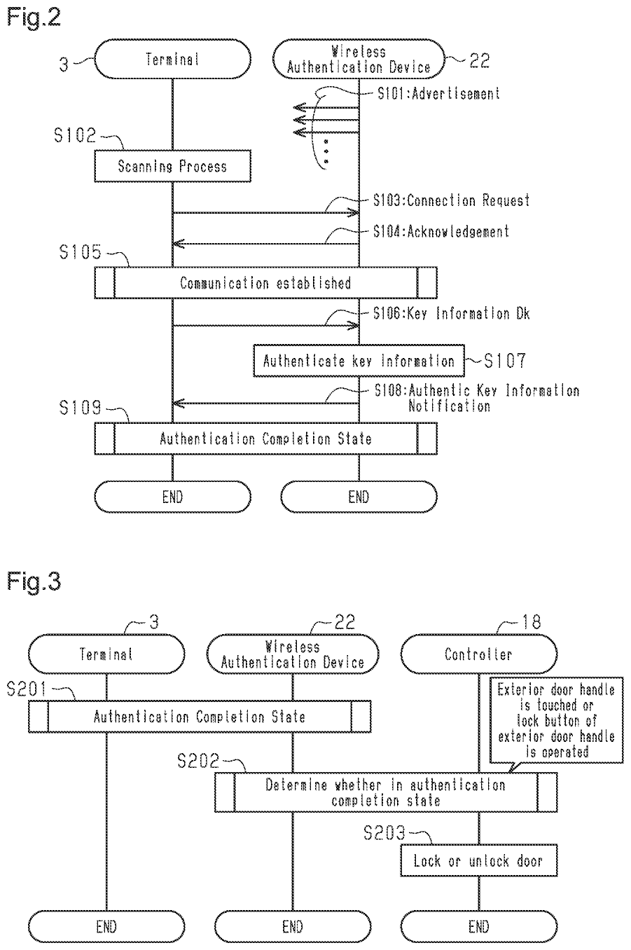

FIG. 2 is a chart showing procedures for authenticating the key information Dk registered to the terminal 3. In step 101 shown in FIG. 2, the authentication unit 23 of the wireless authentication device 22 cyclically transmits an advertisement that announces information related to communication of the wireless authentication device 22. The advertisement is a signal for notifying the terminal 3 of the information related to communication of the wireless authentication device 22 from the authentication unit 23.

In step 102, when the advertisement is received from the wireless authentication device 22 and the received signal strength at the time of receiving the advertisement is greater than or equal to a connection threshold value, the terminal 3 executes a scanning process. In the scanning process, the terminal 3 issues a request for provision of a detail regarding a detail of short-range communication to the wireless authentication device 22 to obtain the detail.

In step 103, after the scanning process, the terminal 3 transmits a connection request for establishing short-range communication to the wireless authentication device 22 through short-range communication so as to be paired with the wireless authentication device 22.

In step 104, when the connection request is received from the terminal 3, the authentication unit 23 of the wireless authentication device 22 transmits an acknowledgment to the terminal 3 in response to the connection request through short-range communication.

In step 105, when the above pairing is properly executed, the authentication unit 23 of the wireless authentication device 22 and the terminal 3 enter a communication established state in which the wireless authentication device 22 and the terminal 3 are connected through Bluetooth communication.

In step 106, when Bluetooth communication is in the communication established state, the terminal 3 transmits the key information Dk from the memory 13 to the wireless authentication device 22 through short-range communication.

In step 107, the authentication unit 23 of the wireless authentication device 22 executes authentication of the key information Dk that is received from the terminal 3. In the present embodiment, for example, when the key information Dk is authentically decrypted and the authentication of the key information Dk is successful, the authentication unit 23 obtains, for example, a session key that will be used in subsequent short-range communication and a terminal ID that is an ID unique to the terminal 3. When the authentication of the key information Dk is not successful, the authentication unit 23 remains in a standby mode and prohibits the terminal 3 from operating the vehicle.

In step 108, when the authentication unit 23 of the wireless authentication device 22 confirms the successful authentication of the key information Dk, the authentication unit 23 of the wireless authentication device 22 transmits an authentic key information notification, which indicates that the authentication of the key information Dk is successful, to the terminal 3 through short-range communication.

In step 109, when the terminal 3 receives the authentic key information notification from the wireless authentication device 22, the terminal 3 and the wireless authentication device 22 both acknowledge the successful authentication and enter an authentication completion state. The authentication completion state is a state in which the terminal 3 and the wireless authentication device 22 both know the common session key and the terminal IDs. Thus, the terminal 3 is allowed to perform a vehicle operation (operation for locking and unlocking a door and operation for starting the engine).

FIG. 3 shows an example of procedures for locking and unlocking a vehicle door through smart entry (registered trademark) without the need for an operation of the terminal 3 when entering the vehicle 2. In the case of smart entry, for example, a touch of the exterior door handle 17 on the vehicle door triggers a start of the unlocking, and an operation of the lock button 17a of the exterior door handle 17 triggers a start of the locking.

In step 201, the terminal 3 and the wireless authentication device 22 enter the authentication completion state through short-range communication. In this step, for example, when the authentication of the key information Dk has been completed and short-range communication is again established, it is preferred that the terminal 3 and the wireless authentication device 22 are authenticated using the session key that was obtained during the decryption of the key information Dk. When the authentication using the key session is successful, the terminal 3 and the wireless authentication device 22 enter the authentication completion state.

In step 202, when the controller 18 detects, for example, a touch of the exterior door handle 17 on the vehicle door or an operation of the lock button 17a of the exterior door handle 17, the controller 18 determines whether the wireless authentication device 22 is in the authentication completion state. When the wireless authentication device 22 is in the authentication completion state, the controller 18 permits the locking and unlocking of the vehicle door. When the vehicle door is locked, a touch of the exterior door handle 17 allows the unlocking of the vehicle door. When the vehicle door is unlocked, an operation of the lock button 17a of the exterior door handle 17 allows the locking of the vehicle door. When the wireless authentication device 22 is not in the authentication completion state, the controller 18 prohibits the locking and unlocking of the vehicle door.

In step 203, when it is confirmed that the wireless authentication device 22 is in the authentication completion state, the controller 18 executes the locking and unlocking of the vehicle door. When the vehicle door is in the locked state and the exterior door handle 17 is touched, the vehicle door is switched to the unlocked state. Thus, the user can open the vehicle door and enter the vehicle 2. When the vehicle door is in a release state and the lock button 17a of the exterior door handle 17 is operated, the vehicle door is switched to the locked state. Thus, the user locks the vehicle door.

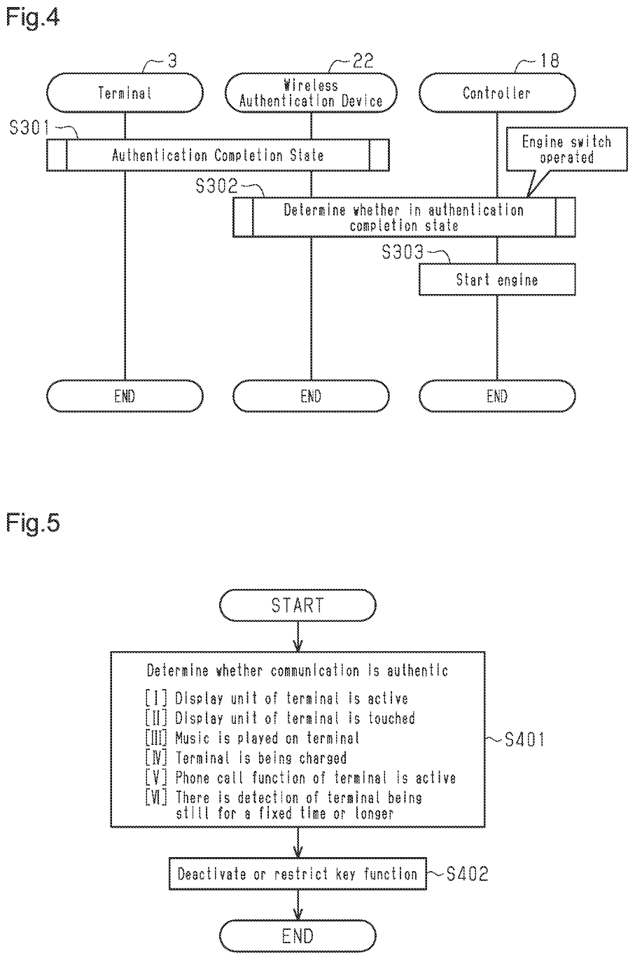

FIG. 4 shows an example of procedures for starting the engine through a smart engine start that dispenses with an operation of the terminal 3 when starting the engine of the vehicle 2. In step 301 shown in FIG. 4, when starting the engine, the terminal 3 and the wireless authentication device 22 enter the authentication completion state in the same manner as when locking or unlocking the vehicle door.

In step 302, for example, when the controller 18 detects an operation of the engine switch 21, the controller 18 determines whether the wireless authentication device 22 is in the authentication completion state. When the wireless authentication device 22 is in the authentication completion state, the controller 18 permits the vehicle power to be switched between different states in accordance with an operation of the engine switch 21. When the wireless authentication device 22 is not in the authentication completion state, the controller 18 prohibits the switching of the vehicle power between different states in accordance with an operation of the engine switch 21.

In step 303, when the controller 18 determines that the wireless authentication device 22 is in the authentication completion state, the controller 18 starts the engine. Thus, the user can drive the vehicle 2 and travel.

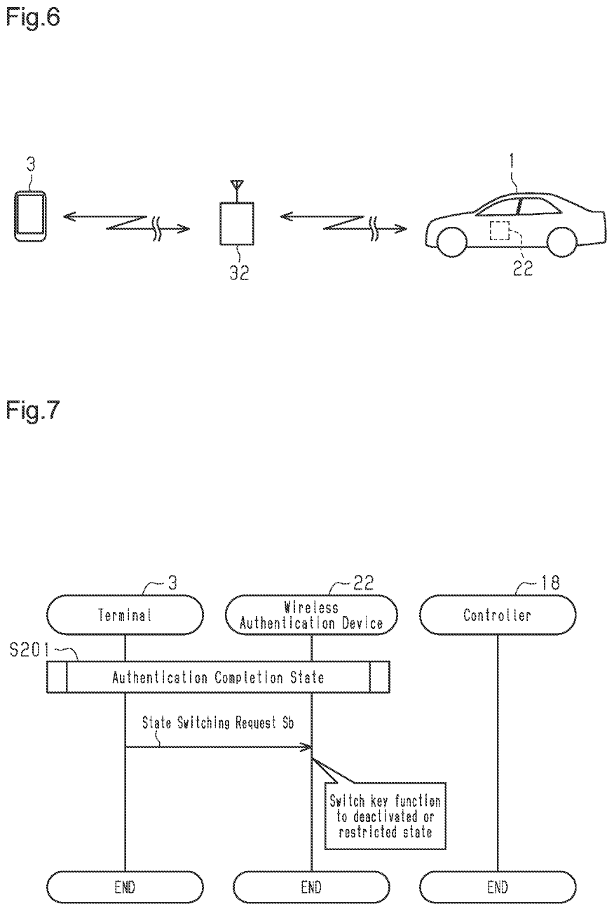

As shown in FIG. 1, the authentication system 4 includes a function (communication system 31) that deactivates or restricts an action (i.e., key function) of the authentication system 4 when there is no intention of the user to operate the vehicle 2 with the terminal 3. The communication system 31 is provided as a countermeasure against, for example, an action of a third party to accomplish fraudulent authentication through short-range communication using one or more relay units 32 (refer to FIG. 6) to fraudulently connect the wireless authentication device 22 to the terminal 3 that is located away from the vehicle 2.

The communication system 31 includes a determination unit 33 that determines whether a condition for deactivating or restricting the key function, which allows the terminal 3 to be used as a key to the vehicle 2, is satisfied. The determination unit 33 is arranged on the terminal 3 (terminal controller 10). When the terminal 3 performs short-range communication with the wireless authentication device 22, the determination unit 33 determines the usage state of the terminal 3 and determines whether the determined usage state of the terminal 3 satisfies the condition for deactivating or restricting the key function. In a preferred example, the determination unit 33 monitors the usage state of the terminal 3 based on the actuation state of a CPU of the terminal controller 10, the connection state of an external terminal connector 34 connected to an external terminal (not shown) such as a connector or a port, the actuation state of various types of functions (e.g., music reproduction function, phone function, and charge function) of the terminal 3, and a detection signal Sa of a detector 35 arranged on the terminal 3. The detector 35 includes a sensor or a switch and is, for example, an acceleration sensor, a gyro sensor, or a magnetic sensor.

Deactivation of the key function refers to a state in which the vehicle 2 is completely inoperable even with the authentic terminal 3. Restriction of the key function refers to a state in which only part of the key function is permitted. For example, only the locking of the vehicle door is permitted in consideration of anti-theft measures.

The communication system 31 includes a processor 36 that executes a process for deactivating or restricting the key function of the terminal 3 based on the determination result of the determination unit 33. The processor 36 is arranged on the terminal 3 (the terminal controller 10). When the determination unit 33 determines that the condition for deactivating or restricting the key function is satisfied, the processor 36 executes the process for deactivating or restricting the key function. The process for deactivating or restricting the key function may be, for example, any one of a process for prohibiting establishment of short-range communication and a process for prohibiting completion of an actuation of the vehicle 2 even when short-range communication is established between the terminal 3 and the wireless authentication device 22.

The operation of the communication system 31 of the present embodiment will now be described with reference to FIGS. 5 to 8.

As shown in FIG. 5, in step 401, when short-range communication is performed, the determination unit 33 determines whether the communication is authentic. That is, the determination unit 33 determines whether the operation of the vehicle 2 with the terminal 3 is intended by a legitimate user. Concrete examples of the determination include the following examples (I) to (VI).
(I) The display unit 12 of the terminal 3 is active.
(II) The display unit 12 of the terminal 3 is touched.
(III) Music is played on the terminal 3.
(IV) The terminal 3 is being charged.
(V) A phone call function of the terminal 3 is active.
(VI) There is a detection of the terminal 3 being still for a fixed time or longer.

In the examples (I) to (V), whether the terminal 3 is being operated in a function other than the key function is an element for the determination. In the example (VI), whether the terminal 3 has been still for a fixed time or longer is an element for the determination. In this case, it is preferred that the determination unit 33 determines whether the terminal 3 is in one of the states (I) to (VI) by monitoring states and outputs of the terminal controller 10, the input portion 11, the display unit 12, the external terminal connector 34, and the detector 35. When the determination unit 33 detects one or more of the states (I) to (VI), the determination unit 33 determines that the key function should be deactivated or restricted.

The state in which the display unit 12 of the terminal 3 is active as described in the example (I) includes, for example, a state in which the screen of the terminal 3 is in an operable mode or a browse mode. The state in which the display unit 12 of the terminal 3 is touched as described in the example (II) includes, for example, a state in which when the display unit 12 is a touch panel, the screen of the display unit 12 is touched in a fixed time or is presently operated. Preferably, whether the terminal 3 is still for a fixed time or longer described in the example (VI) is determined based on the detection signal Sa of the acceleration sensor, the gyro sensor, or the magnetic sensor (compass) used as the detector 35 of the terminal 3.

In step 402, when the determination unit 33 determines that the condition for deactivating or restricting the key function is satisfied, the processor 36 executes the process for deactivating or restricting the key function. The main subject of executing the process for deactivating or restricting the key function may be any of the terminal 3 and the wireless authentication device 22.

FIG. 6 is a diagram showing an example of establishing fraudulent communication using a relay unit 32. As shown in FIG. 6, the terminal 3 that is distant from the vehicle 2 may be fraudulently connected to the wireless authentication device 22 of the vehicle 2 using one or more relay units 32 so that the fraudulent authentication is accomplished. As a result of this action, regardless of there being no intention of the user to use the vehicle 2, the vehicle 2 may be operated and be stolen.

FIG. 7 shows a concrete example of a case for deactivating or restricting the key function after short-range communication is established between the terminal 3 and the wireless authentication device 22. When the determination unit 33 determines that the key function should be deactivated or restricted, the processor 36 transmits a state switching request Sb, which is a request to deactivate or restrict the key function, to the wireless authentication device 22 through short-range communication. The state switching request Sb is encrypted by a session key obtained from the key information Dk and then transmitted.

When the wireless authentication device 22 receives the state switching request Sb from the terminal 3, the key function is switched to the deactivated or restricted state. Thus, even when the wireless authentication device 22 is in the authentication completion state, the wireless authentication device 22 executes an action that prohibits operation of the vehicle 2. Therefore, even when a touch operation is performed on the exterior door handle 17 to unlock the vehicle door through smart entry, the controller 18 does not execute an action for unlocking the vehicle door. Thus, the vehicle door is not unlocked. Also, even when the engine switch is operated in an attempt to start the engine through a smart engine start, the controller 18 prohibits the start of the engine. Thus, the engine is not started.

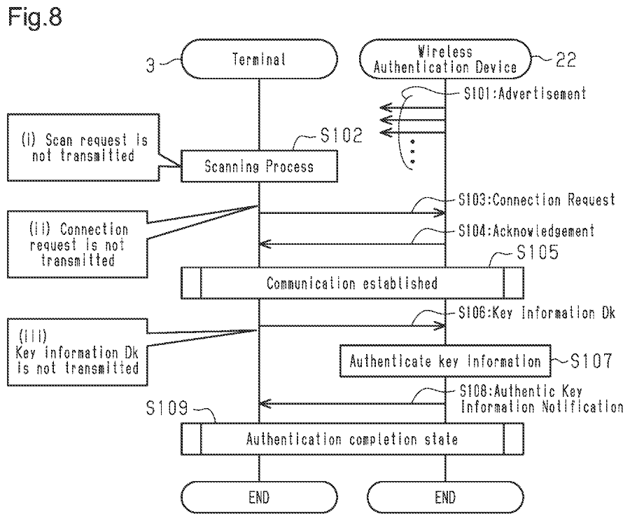

FIG. 8 shows a concrete example of a case for deactivating or restricting the key function by terminating the short-range communication performed between the terminal 3 and the wireless authentication device 22. When the determination unit 33 determines that the key function should be deactivated or restricted, the processor 36 executes an action that does not respond with an electric wave to the wireless authentication device 22 during the short-range communication. Examples of the action that does not respond with an electric wave include the following (i) to (iii).
(i) A scan request is not transmitted during a scanning process.
(ii) A connection request is not transmitted.
(iii) The key information Dk is not transmitted.

In the case of (i), during the scanning process, a scan request is not transmitted from the terminal 3 to the wireless authentication device 22. This fails to complete the scanning process. At this time, the short-range communication is forcibly terminated. In the case of (ii), after the scanning process, a connection request is not transmitted from the terminal 3 to the wireless authentication device 22. This fails to complete transmission of a connection request and an acknowledgment. The short-range communication is forcibly terminated. In the case of (iii), after the short-range communication enters the communication established state, the key information Dk is not transmitted from the terminal 3 to the wireless authentication device 22. This fails to accomplish the authentication of the key information Dk and forcibly terminates the short-range communication.

As described above, when the user is operating the terminal 3 or the terminal 3 has been still for a fixed time or longer, the key function is deactivated or restricted. Thus, there is no need to accomplish the authentication through wireless communication performed between the terminal 3 and the wireless authentication device 22. This ensures security against an establishment of fraudulent communication using the relay unit 32.

The communication system 31 of the embodiment has the following advantages.

(1) The communication system 31 is used for the terminal 3 and the authentication system 4 corresponding to the key function of the wireless authentication device 22. The authentication system 4 executes authentication of the key information Dk through short-range communication performed between the wireless authentication device 22, which is arranged on the vehicle 2 corresponding to the operation subject 1, and the terminal 3, to which the key information Dk is registered. When the authentication is successful, the authentication system 4 allows the terminal 3 to be used as a key to the vehicle 2. The determination unit 33 of the communication system 31 determines the usage state of the terminal 3 during the short-range communication to determine whether the determined usage state of the terminal 3 satisfies a condition for deactivating or restricting the key function. When the determination unit 33 determines that the determined usage state of the terminal 3 satisfies the condition for deactivating or restricting the key function, the processor 36 of the communication system 31 executes the process for deactivating or restricting the key function.

In the terminal 3 that registers the key information Dk and is used as a key to the vehicle 2, the configuration of the present embodiment determines the usage state of the terminal 3 during short-range communication performed between the terminal 3 and the wireless authentication device 22. When the usage state of the terminal 3 satisfies the condition for deactivating or restricting the key function, the key function is deactivated or restricted. Thus, when the usage state indicates that the terminal 3 is less likely to be used as a key to the vehicle 2, the key function is deactivated or restricted. This reduces occurrences of a situation in which the terminal 3 is fraudulently connected to the wireless authentication device 22. Thus, the security against fraudulent communication using the relay unit 32 is ensured.

(2) A determination element of the determination unit 33 is whether the terminal 3 is being operated using a function other than the key function. With this configuration, when the user is operating the terminal 3 using a function other than the key function, even if a third party attempts to establish fraudulent short-range communication using the relay unit 32 or the like, the communication will not be established. From this point, security of short-range communication is ensured.

(3) A determination element of the determination unit 33 is whether the terminal 3 has been still for a fixed time or longer. With this configuration, when the terminal 3 has been left still, even if a third party attempts to establish fraudulent short-range communication using the relay unit 32 or the like, the communication will not be established. From this point, communication security is ensured.

(4) The usage state of the terminal 3 that satisfies the condition for deactivating or restricting the key function is any one of or a combination of two or more of (I) a state in which the display unit 12 of the terminal 3 is active, (II) a state in which a touch operation is performed on the display unit 12 of the terminal 3, (III) a state in which music is played on the terminal 3, (IV) a state in which the terminal 3 is being charged, (V) a state in which a phone call function of the terminal 3 is active, and (VI) a state in which there is a detection of the terminal 3 being still for a fixed time or longer. That is, for the usage state of the terminal 3, the determination unit 33 determines any one of or a combination of two or more of (I) whether the display unit 12 of the terminal 3 is active, (II) whether a touch operation is performed on the display unit 12 of the terminal 3, (III) whether music is played on the terminal 3, (IV) whether the terminal 3 is being charged, (V) whether a phone call function of the terminal 3 is active, and (VI) whether there is a detection of the terminal 3 being still for a fixed time or longer. The determination unit 33 determines whether the determined usage state of the terminal 3 satisfies the condition for deactivating or restricting the key function. Thus, the use of the terminal 3 by a legitimate user is accurately detected.

### Second Embodiment

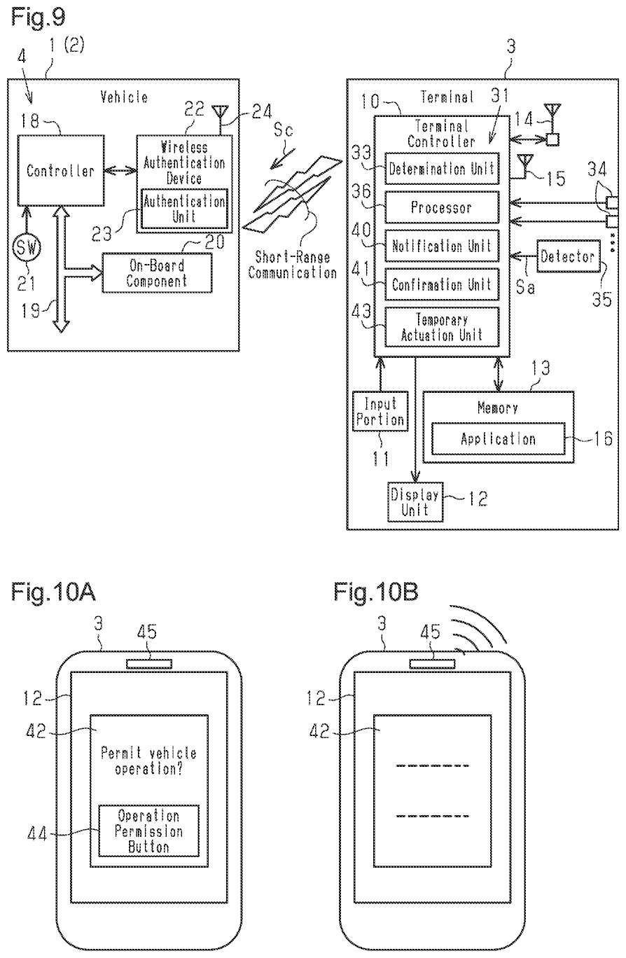

A second embodiment will now be described with reference to FIGS. 9 and 10. The second embodiment is an embodiment in which a type of additional function is added to the communication system 31 of the first embodiment. Therefore, the same reference numerals are given to those parts that are the same as the corresponding parts of the first embodiment. Only the difference from the first embodiment will be described in detail.

As shown in FIG. 9, the communication system 31 includes a notification unit 40. When the key function is deactivated or restricted and the operation subject 1 (in the present embodiment, the vehicle 2) is operated with the terminal 3, the notification unit 40 notifies the user that the key function is deactivated or restricted and the operation subject 1 is operated with the terminal 3. The notification unit 40 is arranged on the terminal 3 (the terminal controller 10). When the key function is deactivated or restricted and the operation subject 1 (in the present embodiment, the vehicle 2) is operated with the terminal 3, the notification unit 40 notifies the user via the terminal 3 that the key function is deactivated or restricted and the operation subject 1 is operated with the terminal 3. In the present embodiment, the notification is, for example, showing a confirmation window 42 on the display unit 12 of the terminal 3.

The communication system 31 includes a confirmation unit 41. When the key function is deactivated or restricted and the operation subject 1 (in the present embodiment, the vehicle 2) is operated with the terminal 3, the confirmation unit 41 requests confirmation from the user whether to cancel the deactivated or restricted state of the key function. The confirmation unit 41 is arranged on the terminal 3 (the terminal controller 10). In a preferred example, when confirming whether to cancel the deactivated or restricted state of the key function, the confirmation unit 41 shows (pop-up-shows) the confirmation window 42 on the display unit 12 of the terminal 3 to charge the user to perform a permitting operation on the confirmation window 42.

The communication system 31 includes a temporary actuation unit 43. When the confirmation unit 41 confirms that a canceling operation of the deactivated or restricted state of the key function is performed, the temporary actuation unit 43 temporarily actuates the key function. The temporary actuation unit 43 is arranged on the terminal 3 (the terminal controller 10). When the confirmation unit 41 confirms that a canceling operation of the deactivated or restricted state of the key function is performed, the temporary actuation unit 43 temporarily cancels the deactivated or restricted state of the key function and activates the key function.

The operation of the communication system 31 of the present embodiment will now be described with reference to FIGS. 10A and 10B.

As shown in FIGS. 10A and 10B, when the key function is deactivated or restricted and an operation for activating the vehicle 2 is performed on the terminal 3, the confirmation unit 41 prompts the user to determine whether to permit the operation. At this time, the notification unit 40 notifies the user that an operation for activating the vehicle 2 is performed when the key function is deactivated or restricted in a visual form (example shown in FIG. 10A) or an auditory form (example shown in FIG. 10B).

In the example shown in FIG. 10A, in addition to the notification from the notification unit 40, the confirmation unit 41 shows (pop-up-shows) the confirmation window 42 on the display unit 12 of the terminal 3 to confirm whether to permit a vehicle operation based on the key function between the terminal 3 and the wireless authentication device 22. When an operation for locking or unlocking a door is performed on the terminal 3, a window asking whether to permit execution of the door locking-unlocking action is shown as the confirmation window 42. When an engine starting operation is performed on the terminal 3, a window asking whether to permit the engine to start is shown as the confirmation window 42. The user checks the confirmation window 42 and performs the canceling operation on the confirmation window 42 if the user intends to permit the vehicle operation based on the key function between the terminal 3 and the wireless authentication device 22.

The canceling operation includes an operation actively performed by the user on the terminal 3. In the present embodiment, the confirmation window 42 includes an operation permission button 44, and the operation permission button 44 is touched. Examples of the touch operation include two or more actions of each operation including tapping, sliding, wiping, and shaking of the terminal 3.

In the example shown in FIG. 10B, in addition to the notification from the notification unit 40, the confirmation unit 41 sends (outputs) a message from a speaker 45 of the terminal 3 to confirm whether to permit a vehicle operation based on the key function between the terminal 3 and the wireless authentication device 22. At this time, it is preferred that the confirmation unit 41 shows the confirmation window 42, which has been described, on the display unit 12. The user receives the audio message and performs the touching operation on the operation permission button 44 of the confirmation window 42 if the user intends to permit the vehicle operation based on the key function between the terminal 3 and the wireless authentication device 22.

When it is detected that the operation permission button 44 of the confirmation window 42 is operated, the temporary actuation unit 43 temporarily cancels the deactivated or restricted state of the key function and activates the key function. In the present embodiment, the temporary actuation unit 43 transmits a temporary cancel request Sc (refer to FIG. 9), which is a request to temporarily cancel the key function, to the wireless authentication device 22 through short-range communication. When the temporary cancel request Sc is received from the terminal 3, the wireless authentication device 22 enters a state in which the key function is temporarily permitted. The temporary cancel is not limited to permission of a single operation and may be permission of a predetermined number of operations or permission of operation for a fixed length of time.

In the authentication completion state, the wireless authentication device 22 permits the locking and unlocking of the vehicle door through smart entry. In the authentication completion state, the controller 18 unlocks the vehicle door when detecting a touching operation of the exterior door handle 17, and locks the vehicle when detecting an operation of the lock button 17a of the exterior door handle 17. Thus, even when a legitimate user is using the terminal 3 in a function other than the key function, the operation for locking and unlocking the vehicle door is permitted.

In addition, in the authentication completion state, the wireless authentication device 22 permits the starting of the engine through a smart engine start. In the authentication completion state, when it is detected that the engine switch 21 is operated while the brake pedal is depressed, the controller 18 switches the engine to the start state. Thus, even when a legitimate user is operating the terminal 3 using a function other than the key function, the switching of the engine to the start state is permitted.

The communication system 31 of the above embodiment has the following advantages in addition to the advantages (1) to (4) of the first embodiment.

(5) When the key function is deactivated or restricted and the vehicle 2 is operated with the terminal 3 using the key function, the notification unit 40 of the communication system 31 notifies the user via the terminal 3 that the vehicle 2 is operated with the terminal 3 using the key function. With this configuration, when fraudulent communication is established between the vehicle 2 and the terminal 3 despite the deactivated or restricted state of the key function, the situation is notified to the user.

(6) When the key function is deactivated or restricted and the vehicle 2 is operated with the terminal 3 using the key function, the confirmation unit 41 of the communication system 31 requests confirmation from the user whether to permit to cancel the deactivated or restricted state of the key function via the terminal 3. With this configuration, when the key function is deactivated or restricted and a legitimate user wishes to operate the vehicle 2 with the terminal 3, the user may confirm whether to permit to cancel the deactivated or restricted state of the key function.

(7) When the confirmation unit 41 confirms that the canceling operation of the deactivated or restricted state of the key function is performed, the temporary actuation unit 43 of the communication system 31 temporarily cancels the deactivated or restricted state of the key function and activates the key function. With this configuration, when the key function is deactivated or restricted and a legitimate user wishes to operate the vehicle 2 with the terminal 3, the user may operate the vehicle 2 with the terminal 3.

(8) The canceling operation includes an operation actively performed by the user on the terminal 3. Unless the user intentionally operates the terminal 3, the key function remains in the deactivated or restricted state. This limits occurrence of fraudulent cancellation.

### Third Embodiment

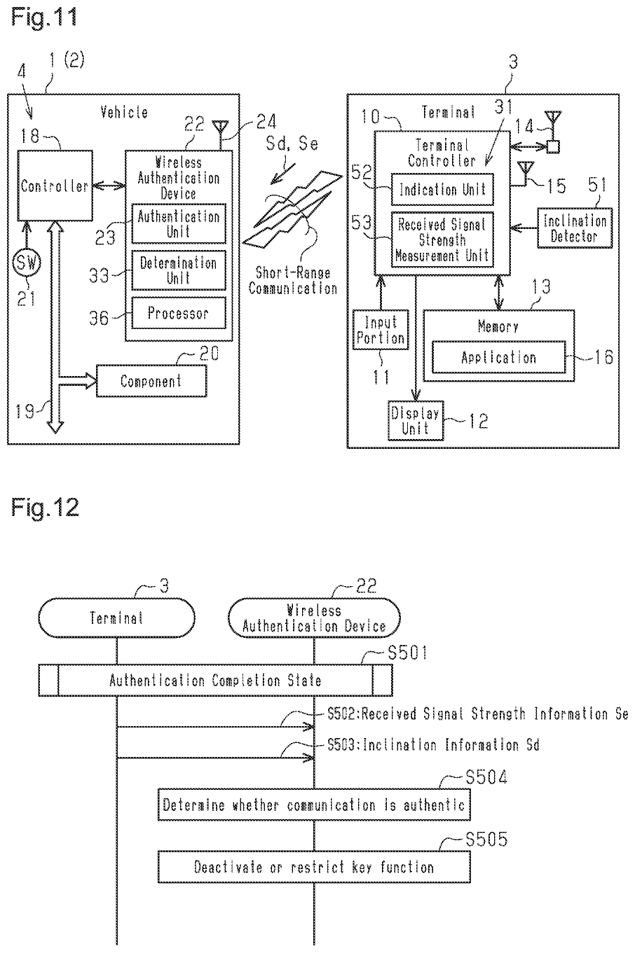

A third embodiment will now be described with reference to FIGS. 11 and 12. In the third embodiment, the differences from the first and second embodiments will be described.

As shown in FIG. 11, the terminal 3 includes an indication unit 52 that sends inclination information Sd, which is an output of an inclination detector 51 configured to detect an inclination of the terminal 3, to the wireless authentication device 22 through short-range communication. The indication unit 52 is arranged on the terminal controller 10. Preferably, when the terminal 3 and the wireless authentication device 22 perform communication for authentication, the indication unit 52 sends the inclination information Sd to the wireless authentication device 22 during the communication. Examples of the inclination detector 51 include an acceleration sensor and a gyro sensor in addition to an inclination sensor.

In the present embodiment, the determination unit 33 and the processor 36 are arranged on the wireless authentication device 22. When the determination unit 33 determines that the terminal 3 has not been operated for a fixed time or longer based on the inclination information Sd received from the terminal 3, the determination unit 33 determines that the key function should be deactivated or restricted. When the determination unit 33 determines that the key function should be deactivated or restricted, the processor 36 executes the process for deactivating or restricting the key function.

Preferably, when the terminal 3 and the wireless authentication device 22 perform communication with each other, the indication unit 52 measures a received signal strength indicator (RSSI) of an electric wave and indicates received signal strength information Se to the wireless authentication device 22 through short-range communication. For example, the terminal controller 10 includes a received signal strength measurement unit 53, and the terminal 3 measures the received signal strength indicator of the electric wave received from the wireless authentication device 22 with the received signal strength measurement unit 53. In a preferred example, the received signal strength measurement unit 53 measures the received signal strength indicator when the terminal 3 receives advertisements regularly and repeatedly transmitted from the wireless authentication device 22.

When both the inclination information Sd and the received signal strength information Se are received from the terminal 3, the determination unit 33 determines whether to deactivate or restrict the key function based on the inclination information Sd and the received signal strength information Se. That is, when both the inclination information Sd and the received signal strength information Se are received from the terminal 3, the determination unit 33 uses the inclination information Sd and the received signal strength information Se to determine whether the terminal 3 has been operated for a fixed time or longer. The processor 36 executes the process for deactivating or restricting the key function based on the determination result of the determination unit 33.

The operation of the communication system 31 of the present embodiment will now be described with reference to FIG. 12.

In step 501, the terminal 3 and the wireless authentication device 22 enter the authentication completion state through short-range communication in the same manner as when the vehicle door is locked or unlocked or the engine is started.

In step 502, the indication unit 52 transmits the received signal strength information Se of electric waves that are transmitted through short-range communication between the terminal 3 and the wireless authentication device 22 to the wireless authentication device 22 through short-range communication. In an example, when the received signal strength indicator is measured from advertisements, the terminal 3 measures the received signal strength indicator with the received signal strength measurement unit 53 and stores the data whenever an advertisement is received. The received signal strength information Se includes a group of data entries that are measured by the terminal whenever receiving an advertisement, and the indication unit 52 transmits the received signal strength information Se to the wireless authentication device 22 through short-range communication. Preferably, the received signal strength information Se is encrypted by a session key and transmitted.

In step 503, the indication unit 52 transmits the inclination information Sd, which is detected by the inclination detector 51 of the terminal 3, to the wireless authentication device 22 through short-range communication. In the present embodiment, it is preferred that the inclination information Sd includes a group of data entries that are intermittently detected. The inclination information Sd may be data including data that is measured before short-range communication enters the authentication completion state or a data group that is obtained after short-range communication enters the authentication completion state.

In step 504, the determination unit 33 determines whether the short-range communication is authentic based on the inclination information Sd and the received signal strength information Se received from the terminal 3. That is, the determination unit 33 checks the inclination information Sd and the received signal strength information Se received from the terminal 3 to determine whether the short-range communication is fraudulent communication. In the present embodiment, the condition for authentic short-range communication is satisfied when the received signal strength indicator is high and there is a change in the inclination of the terminal 3.

When the inclination of the terminal 3 is fixed, it is highly likely that a third party is using the relay unit 32 to fraudulently connect the terminal 3 to the wireless authentication device 22 of the vehicle 2. At this time, if the determination is made based on only the received signal strength information Se and a determination result shows that the received signal strength indicator is high, it may be determined from the determination result that the communication is authentic. This may lead to fraudulent unlocking of the vehicle door or a fraudulent start of the engine. In the present embodiment, a change in the inclination information Sd is a determination element in addition to the received signal strength indicator. It will not be determined that the communication is authentic unless there is a change in the inclination of the terminal 3. Thus, even when a third party uses the relay unit 32 to fraudulently establish communication, it is determined that the communication is fraudulent, and the vehicle 2 will not be activated. This prevents a third party from fraudulently operating the vehicle 2.

When the determination unit 33 of the present embodiment finds the received signal strength indicator is greater than or equal to a specified value and there is a change in the inclination of the terminal 3, the determination unit 33 of the present embodiment determines that the present short-range communication is authentic communication. When the determination unit 33 finds that at least one of a state in which the received signal strength indicator is less than the specified value and a state in which there is no change in the inclination of the terminal 3, the determination unit 33 determines that the present short-range communication is fraudulent communication.

In step 505, the processor 36 deactivates or restricts the key function based on the determination result of the determination unit 33. More specifically, when the determination unit 33 determines that the present short-range communication is fraudulent communication, the processor 36 executes the process for deactivating or restricting the key function. With this configuration, the communication will not be established even if a third party attempts to establish fraudulent communication using the relay unit 32.

The communication system 31 of the above embodiment has the following advantages in addition to the advantages (1) to (8) of the first and second embodiments.

(9) A determination element of the determination unit 33 is whether the terminal 3 has been still for a fixed time or longer. The terminal 3 includes the indication unit 52 that transmits the inclination information Sd, which is detected by the inclination detector 51 in the terminal 3, to the wireless authentication device 22 through short-range communication. The determination unit 33 is arranged on the wireless authentication device 22. When it is determined that the terminal 3 has been still for a fixed time or longer based on the inclination information Sd, the determination unit 33 determines that the key function should be deactivated or restricted. The processor 36 is arranged on the wireless authentication device 22. When the determination unit 33 determines that the key function should be deactivated or restricted, the processor 36 executes the process for deactivating or restricting the key function.

This configuration uses the inclination information Sd, which is detected by the inclination detector 51 arranged on the terminal. This allows for accurate determination of whether the terminal 3 has been still for a fixed time or longer. In addition, since the determination unit 33 and the processor 36 are arranged on the wireless authentication device 22, the terminal 3 does not need to have the functions of the determination unit 33 and the processor 36. Thus, the terminal 3 does not need to execute a high-load process.

(10) The indication unit 52 indicates the received signal strength information Se of electric waves that are measured during short-range communication between the terminal 3 and the wireless authentication device 22 to the wireless authentication device 22 through short-range communication. The determination unit 33 determines whether to deactivate or restrict the key function based on the inclination information Sd and the received signal strength information Se. This configuration uses both the inclination information Sd and the received signal strength information Se. This allows for accurate determination of whether the key function should be deactivated or restricted, that is, whether the communication is fraudulent communication.

The embodiments may be modified as follows. The embodiments and the following modified examples can be combined as long as the combined modified examples remain technically consistent with each other.

Usage State of Terminal 3

In each embodiment, the usage state of the terminal 3 includes a state determining whether the user is operating the terminal 3.

In each embodiment, the usage state of the terminal 3 includes a state determining whether the terminal 3 is active, that is, whether a screen or an image is shown on the display unit 12.

Determination of Whether to Deactivate or Restrict Key Function

In the third embodiment, when determination is made based on the received signal strength indicator, for example, a received signal strength indicator, a moving average, and a weighted arithmetic mean may be obtained, and whether the received signal strength indicator is appropriate may be determined from the obtained values.

In each embodiment, a sensor and a switch that are used to determine whether to deactivate or restrict the key function may be an existing member of the terminal 3 or a member additionally arranged on the terminal 3.

In each embodiment, notification of the notification unit 40 may be issued in any manner as long as the user notices it. Notification may be issued by a device or a component other than the terminal 3.

In each embodiment, the canceling operation may be performed in accordance with, for example, a voice input. Thus, any operation from which an intention of the user to cancel is acknowledged suffices the canceling operation.

Wireless Authentication Device 22

In each embodiment, the antenna 24 of the wireless authentication device 22 may have directionality in a particular direction.

In each embodiment, the wireless authentication device 22 may be a member originally installed on the vehicle 2 or a member retrofit to the vehicle 2.

Key Information Dk

In each embodiment, the key information Dk is not limited to a one-time key (one-time password) and may be various types of keys.

In each embodiment, the key information Dk is not limited to that delivered from the server 5 to the terminal 3 and may be delivered to the terminal 3 from a location other than the server 5. For example, the key information Dk may be provided from another terminal 3.

In each embodiment, the authentication of the key information Dk is not limited to decryption of the key information Dk and may be any authentication that determines the authenticity of the key information Dk.

Key Function

In each embodiment, the key function is not limited to the authentication system 4 and may be used in any system in which the terminal 3 is used as a key to the vehicle 2.

In each embodiment, the key function is not limited to the authentication of a key that is needed when permitting the locking and unlocking of the vehicle door or a start of the engine. The key function includes various operations related to the vehicle 2 such as the opening and closing of a sliding door or the opening of a trunk.

Others

In the second embodiment, when the key function is deactivated or restricted and the operation subject 1 is operated with the terminal 3 using the key function, only a notification of the key function being deactivated or restricted and the operation subject 1 being operated with the terminal 3 using the key function may be issued. In this case, the confirmation unit 41 and the temporary actuation unit 43 are omitted, and only the notification unit 40 is arranged.

In each embodiment, the vehicle 2 may be a shared vehicle that is shared by a number of people. Examples of sharing include sharing of a single vehicle 2 among particular users such as family members, carsharing where a vehicle 2 is temporarily rented, and ridesharing where a number of people share a ride on a single vehicle 2.

In each embodiment, the function provision unit 6 is not limited to that arranged on the server 5 and may be arranged on another terminal.

In each embodiment, the operation subject 1 is not limited to the vehicle 2 and may be a device or component that is operated with the terminal 3 as a key to the device or component. That is, the vehicle 2 is an example of the operation subject 1 that performs wireless communication with the terminal 3. The term “operation subject” used in the present disclosure is defined as a communication body that has an external region and internal region (or, closed space) separated from the external region and includes a communication device (e.g., the wireless authentication device 22) disposed in the internal region. The communication body systematically execute various processes (including authentication and determination) of the present disclosure through wireless communication with the terminal 3. Besides a vehicle, a communication subject may be, for example, a house, a building, or any communication subject on which the above communication device is arranged.

The function provision unit 6, the terminal controller 10 (the determination unit 33, the processor 36, the notification unit 40, the confirmation unit 41, the temporary actuation unit 43, the indication unit 52, and the received signal strength measurement unit 53), the controller 18, and the authentication unit 23 may be configured to be circuitry that includes one or more processors that execute various processes in accordance with computer programs (software), one or more dedicated hardware circuits that execute at least some of various processes such as application specific integrated circuits (ASICs), or a combination of these. The processor includes a central processing unit (CPU) and memory such as random access memory (RAM) and read only memory (ROM). The memory stores a program code or a command that causes the CPU to execute a process. The memory, or a computer readable medium, includes any type of medium that is accessible by a general-purpose computer and a dedicated computer.

The present disclosure includes the following embodiment. In the following embodiment, some of the elements may be omitted or may be selected or extracted to be combined with each other.

Clause

1. A system according to one or more of the embodiments of the present disclosure, including:

one or more processors; and

one or more memories that store commands executable by the one or more processors, wherein

the commands are executed to cause the one or more processors to execute authentication of key information that is registered to a terminal through short-range communication performed between the terminal and a wireless authentication device arranged on an operation subject,

a key function that allows the terminal to be used as a key to the operation subject when the authentication is successful,

determination of whether a usage state of the terminal during the short-range communication satisfies a condition for deactivating or restricting the key function, and

deactivation or restriction of the key function when it is determined that the usage state of the terminal satisfies the condition for deactivating or restricting the key function.

1. A communication system used for a key function that executes authentication of key information that is registered to a terminal through short-range communication performed between the terminal and a wireless authentication device arranged on an operation subject, and when the authentication is successful, allows the terminal to be used as a key to the operation subject, the communication system comprising:
a determination unit that determines a usage state of the terminal during the short-range communication and determines whether the determined usage state of the terminal satisfies a condition for deactivating or restricting the key function; and
a processor that executes a process for deactivating or restricting the key function when the determination unit determines that the determined usage state of the terminal satisfies the condition for deactivating or restricting the key function.

2. The communication system according to claim 1, further comprising: a notification unit, wherein when the key function is in a deactivated or restricted state and the operation subject is operated with the terminal using the key function, the notification unit notifies a user via the terminal that the key function is in the deactivated or restricted state and the operation subject is operated with the terminal using the key function.

3. The communication system according to claim 1, further comprising: a confirmation unit, wherein when the key function is in a deactivated or restricted state and the operation subject is operated with the terminal using the key function, the confirmation unit requests confirmation from a user via the terminal whether to cancel the deactivated or restricted state of the key function.

4. The communication system according to claim 3, further comprising: a temporary actuation unit, wherein when the confirmation unit confirms that a canceling operation of the deactivated or restricted state of the key function is performed, the temporary actuation unit temporarily cancels the deactivated or restricted state of the key function and activates the key function.

5. The communication system according to claim 4, wherein the canceling operation includes an operation actively performed by the user on the terminal.

6. The communication system according to claim 1, wherein determining whether the determined usage state of the terminal satisfies the condition for deactivating or restricting the key function with the determination unit includes determining whether the terminal is being operated using a function other than the key function.

7. The communication system according to claim 1, wherein the usage state of the terminal that satisfies the condition for deactivating or restricting the key function is any one of or a combination of two or more of a state in which a display unit of the terminal is active, a state in which a touch operation is performed on the display unit of the terminal, a state in which music is played on the terminal, a state in which the terminal is being charged, a state in which a phone call function of the terminal is active, and a state in which there is a detection of the terminal being still for a fixed time or longer.

8. The communication system according to claim 1, wherein
determining whether the determined usage state of the terminal satisfies the condition for deactivating or restricting the key function with the determination unit includes determining whether the terminal has been still for a fixed time or longer,
the terminal further includes an indication unit that sends inclination information to the wireless authentication device through the short-range communication, the inclination information being detected by an inclination detector in the terminal,
the determination unit is arranged on the wireless authentication device and determines that the key function should be deactivated or restricted when the determination unit determines that the terminal has been still for the fixed time or longer based on the inclination information, and
the processor is arranged on the wireless authentication device and executes a process for deactivating or restricting the key function when the determination unit determines that the key function should be deactivated or restricted.

9. The communication system according to claim 8, wherein
the indication unit indicates received signal strength information of an electric wave, which is measured during the short-range communication performed between the terminal and the wireless authentication device, to the wireless authentication device through the short-range communication, and
the determination unit determines whether the key function should be deactivated or restricted based on the inclination information and the received signal strength information.

10. A communication method used for a key function that executes authentication of key information that is registered to a terminal through short-range communication performed between the terminal and a wireless authentication device arranged on an operation subject, and when the authentication is successful, allows the terminal to be used as a key to the operation subject, the communication method, comprising:
determining, with a determination unit, a usage state of the terminal during the short-range communication to determine whether the determined usage state of the terminal satisfies a condition for deactivating or restricting the key function; and
executing, with a processor, a process for deactivating or restricting the key function when the determination unit determines that the determined usage state of the terminal satisfies the condition for deactivating or restricting the key function.
